(19) United States
(12) Patent Application Publication
(10) Pub. No.: US 2024/0357632 A1
(43) Pub. Date: Oct. 24, 2024

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 18/274,096

(22) PCT Filed: Feb. 26, 2021
(86) PCT No.: PCT/CN2021/078226

§ 371 Date: Jul. 25, 2023

(51) Int. Cl. H04W 72/56; H04W 72/12; H04W 88/06

(52) U.S. Cl. CPC H04W 72/56; H04W 72/12; H04W 88/06

(57) ABSTRACT

Embodiments of the present disclosure relate to methods, devices and computer readable media for communication. A method of communication comprises receiving, at a terminal device, a configuration of a scheduling gap from a first network device, the scheduling gap being configured for a portion of serving cells of the first network device; and switching, based on the configuration of the scheduling gap, to a second network device while maintaining a radio resource control connection with the first network device. Thereby, a scheduling gap with a smaller granularity can be configured and used, and thus an interruption of a service at the first network device can be avoided as much as possible.

### TECHNICAL FIELD

Embodiments of the present disclosure generally relate to the field of telecommunication, and in particular, to methods, devices and computer storage media of communication during a switch among networks of multi-universal subscriber identity module (USIM).

### BACKGROUND

Currently, a multi-USIM terminal device occupies a large market share. Two USIMs may conform to same or different communication standards such as long term evolution (LTE), new radio (NR) or the like, and the capability of the terminal device may be 1 transmit (Tx)/1 receive (Rx), 1Tx/2Rx, 2Tx/1Rx or the like. 2Rx (Dual Rx) allows the multi-USIM terminal device to simultaneously receive traffic from two networks. 1Tx (Single Tx) allows the multi-USIM terminal device to transmit traffic to one network at one time. 2Tx (Dual Tx) allows the multi-USIM terminal device to simultaneously transmit traffic to two networks. The terms Single Rx/Tx and Dual Rx/Tx do not refer to a device type. A single terminal device may, as an example, uses Dual Tx in some cases but Single Tx in other cases.

In some scenarios, a multi-USIM terminal device may establish a connection in a network A of USIM A and stay in an idle or inactive state in a network B of USIM B. Conventionally, when the terminal device needs to operate in the network B, such as perform data transmission or monitor paging occasion, the terminal device just releases the connection with the network A and switches to the network B without noticing the network A. This will bring a bad impact to performance of the network A.

### SUMMARY

In general, embodiments of the present disclosure provide methods, devices and computer storage media for communication during a switch among networks of multi-USIM.

In a first aspect, there is provided a method of communication. The method comprises: receiving, at a terminal device, a configuration of a scheduling gap from a first network device, the scheduling gap being configured for a portion of serving cells of the first network device; and switching, based on the configuration of the scheduling gap, to a second network device while maintaining a radio resource control (RRC) connection with the first network device, the first network device being associated with a first subscriber identity module of the terminal device and the second network device being associated with a second subscriber identity module of the terminal device.

In a second aspect, there is provided a method of communication. The method comprises: generating, at a first network device, a configuration of a scheduling gap for a switch of a terminal device to a second network device while maintaining a radio resource control connection with the first network device, the scheduling gap being configured for a portion of serving cells of the first network device, the first network device being associated with a first subscriber identity module of the terminal device and the second network device being associated with a second subscriber identity module of the terminal device; and transmitting the configuration to the terminal device.

In a third aspect, there is provided a method of communication. The method comprises: determining, at a terminal device, whether a first gap for a network device is overlapped with a second gap for the network device, the first gap being a scheduling gap, the second gap being another scheduling gap or a measurement gap; and in accordance with a determination that the first gap is overlapped with the second gap, determining a first period within the overlapped period for performing a first operation corresponding to the first gap and a second period within the overlapped period for performing a second operation corresponding to the second gap.

In a fourth aspect, there is provided a terminal device. The terminal device comprises a processor and a memory coupled to the processor. The memory stores instructions that when executed by the processor, cause the terminal device to perform the method according to at least one of the first or third aspect of the present disclosure.

In a fifth aspect, there is provided a network device. The network device comprises a processor and a memory coupled to the processor. The memory stores instructions that when executed by the processor, cause the network device to perform the method according to the second aspect of the present disclosure.

In a sixth aspect, there is provided a computer readable medium having instructions stored thereon. The instructions, when executed on at least one processor, cause the at least one processor to perform the method according to at least one of the first or third aspect of the present disclosure.

In a seventh aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication scenario in which some embodiments of the present disclosure can be implemented:

FIG. 1B illustrates a schematic diagram illustrating an example component of a network device in the example communication network;

FIG. 2 illustrates a schematic diagram illustrating a process for communication during a switch among networks of multi-USIM according to some embodiments of the present disclosure:

FIG. 3 illustrates a schematic diagram illustrating a process for handling the overlapping among gaps according to some embodiments of the present disclosure:

FIG. 4 illustrates an example method of communication implemented at a terminal device in accordance with some embodiments of the present disclosure:

FIG. 5 illustrates an example method of communication implemented at a network device in accordance with some embodiments of the present disclosure:

FIG. 6 illustrates another example method of communication implemented at a terminal device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different RATs. In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device.

In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “subscriber identity module (SIM)” refers to a universal subscriber identity module used in a terminal device. Examples of the SIM include, but not limited to, SIM card, USIM card, ISIM card, or the like. The term “SIM” can be used interchangeably with a USIM or ISIM.

Assuming that a multi-USIM terminal device has established a connection in a network A of USIM A and stays in an idle or inactive state in a network B of USIM B. In this case, if the terminal device needs to handle an incoming service from the network B, the terminal device may perform a switch to the network B. For example, in some scenarios, if the incoming service is a long-time service such as a voice over LTE (VOLTE) or voice over NR (VONR) voice call or the like, the terminal device may perform a long-time switching. During the long-time switching, the terminal device may release the connection with the network A and switch to the network B. For example, the terminal device may transmit a request for the long-time switching to the network A, and release the connection to switch to the network B in response to receiving a RRCRelease message from the network B. In some other scenarios, if the incoming service is a short-time service such as a paging reception, measurements, a tracking area update (TAU), a radio access network (RAN)-based notification area update (RNAU), a mobile-originated short message service (MO SMS) or the like, the terminal device may perform a short-time switching. During the short-time switching, the terminal device may maintain the connection with the network A and temporarily switch to the network B.

For the short-time switching, a scheduling gap has been proposed during which the terminal device does not perform any uplink (UL) or downlink (DL) transmission and physical downlink control channel (PDCCH) monitoring on serving cells of the network A, except for random access related procedure. For example, the terminal device may transmit a request for the short-time switching to the network A, and receive a configuration of the scheduling gap from the network A. The terminal device may switch to the network B during the scheduling gap to handle the incoming service, and return to the network A upon or before an end of the scheduling gap. However, if a per-UE scheduling gap is adopted, i.e., the scheduling gap is applied to all serving cells, there will be service interruption on all the serving cells in the network A. In particular, it is inappropriate for a terminal device with high capabilities, e.g., 2 Rx/1 Tx or 2Rx/2Tx. Thus, it is expected to avoid an impact on a service at the network A as much as possible.

In view of this, one aspect of embodiments of the present disclosure provides a solution of applying or supporting a scheduling gap with a smaller granularity. In this way, impact on a service at the network A can be avoided as much as possible.

In some cases where a measurement gap is also applied during which the terminal device performs measurements for the network A, the scheduling gap may be overlapped with the measurement gap. However, the terminal device is not able to perform measurement for the network A and receive/transmit data from/to the network B at the same time.

In some other cases, to cope with different short-time service at the network B with difference traffic pattern, multiple scheduling gaps may be configured to the terminal device. For example, one of the scheduling gaps is configured for IDLE/INACTIVE mode measurement and another one of the scheduling gaps is configured for paging monitoring. In this case, one scheduling gap may be overlapped with another scheduling gap. However, the terminal device may not able to perform the IDLE/INACTIVE mode measurement and the paging monitoring for the network B at the same time.

In view of this, another aspect of embodiments of the present disclosure provides a solution of handling or solving the overlapping among gaps. In this way, the behavior of the terminal device during the overlapped period can be specified.

Principles and implementations of the present disclosure will be described in detail below with reference to the figures.

### Example of Communication Network

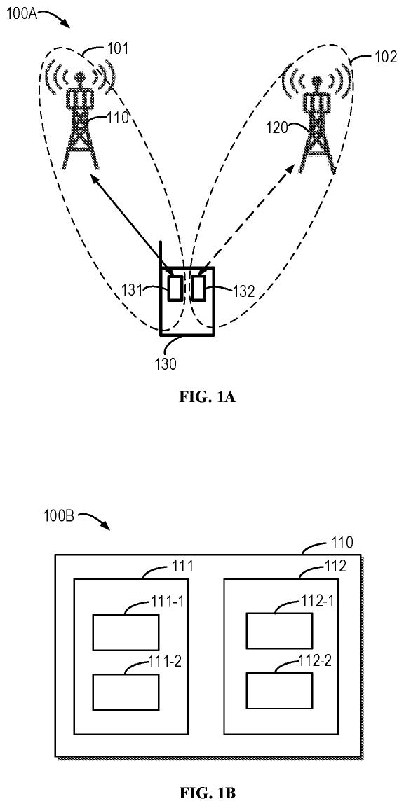

FIG. 1A illustrates a schematic diagram of an example communication scenario 100A in which embodiments of the present disclosure can be implemented. As shown in FIG. 1A, the communication scenario 100A may involve a first communication network 101 comprising a first network device 110 and a second communication network 102 comprising a second network device 120. It is to be understood that the first network device 110 is merely an example of network devices in the first communication network 101, and in fact, the first communication network 101 may further comprise more network devices. Similarly, the second network device 120 is merely an example of network devices in the second communication network 102, and in fact, the second communication network 102 may further comprise more network devices.

The communication scenario 100A may also involve a terminal device 130 carrying a first USIM 131 and a second USIM 132. The first USIM 131 communicates with external environment via the first communication network 101, and the second USIM 132 communicates with external environment via the second communication network 102. That is, the first USIM 131 is served by network devices in the first communication network 101, and the first USIM 132 is served by network devices in the second communication network 102.

The first and second USIMs 131 and 132 may conform same or different RATs which are existing now or to be developed in the future. That is, the first and second communication networks 101 and 102 may conform same or different RATs. It should be noted that the number of the USIMs carried by the terminal device 130 is not limited to two, and more than two USIMs also can be applied. Accordingly, it is also to be noted that the communication scenario 100A may involve more communication networks serving the USIMs. For convenience, the following description is given by taking two USIMs and two corresponding communication networks as an example.

It is to be understood that the first network device 110 may also support the second communication network 102, and the second network device 120 may also support the first communication network 101. Thus, the first network device 110 may serve at least one of the first and second USIMs 131 and 132. The second network device 120 may also serve at least one of the first and second USIMs 131 and 132. For convenience, unless otherwise stated, the following description is made under the assumption that the first network device 110 serves the first USIM 131 and the second network device 120 serves the second USIM 132. However, it should be noted that, it is merely an example for illustration, and does not make limitation for the present disclosure. For example, the first and second USIMs 131 and 132 may be served by the same network device such as the first network device 110 or the second network device 120.

The first network device 110 may communicate with the terminal device 130 via a channel such as a wireless communication channel. Similarly, the second network device 120 may also communicate with the terminal device 130 via a channel such as a wireless communication channel. In some embodiments where the first network device 110 supports the first communication network 101 and the second network device 120 supports the second communication network 102, the first USIM 131 may communicate with the first network device 110, and the second USIM 132 may communicate with the second network device 120. In some embodiments where the first network device 110 supports the second communication network 102 and the second network device 120 supports the first communication network 101, the first USIM 131 may communicate with the second network device 120, and the second USIM 132 may communicate with the first network device 110. In some embodiments where the first network device 110 supports both the first and second communication network 101 and 102, both the first USIM 131 and the second USIM 132 may communicate with the first network device 110. In some embodiments where the second network device 120 supports both the first and second communication network 101 and 102, both the first USIM 131 and the second USIM 132 may communicate with the second network device 120.

It is to be understood that the number of devices in FIG. 1A is given for the purpose of illustration without suggesting any limitations to the present disclosure. The communication scenario 100A may include any suitable number of network devices and/or terminal devices adapted for implementing implementations of the present disclosure.

The communications in the communication scenario 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

FIG. 1B illustrates a schematic diagram 100B illustrating an example component of a network device in the example communication scenario 100A. For illustration, FIG. 1B will be described in connection with the first network devices 110. It is to be understood that the description on FIG. 1B also apply to other network devices in the communication scenario 100A that shown or not shown. As shown in FIG. 1B, the first network device 110 may comprise a master node (MN) 111 and a secondary node (SN) 112. It is to be understood that the MN 111 and the SN 112 may be implemented as network devices. The MN 111 may have serving cells 111-1 and 111-2, and the SN 112 may have serving cells 112-1 and 112-2. The group of serving cells associated with MN 111 (i.e. master cell group, MCG) may comprise a primary cell (PCell) and at least one secondary cell (SCell), and the group of serving cells associated with the SN 112 (i.e. secondary cell group, SCG) may comprise a primary secondary cell (PSCell) and at least one secondary cell (SCell). It is to be understood that each of the MCG and SCG may have more or less serving cells, and is not limited to that shown.

Return to FIG. 1A, assuming that the terminal device 130 establishes a connection between the first USIM 131 and the first network device 110, and stays in an idle state or in an inactive state between the second USIM 132 and the second network device 120. When the terminal device 130 is to perform transmission or reception between the second USIM 132 and the second network device 120, the terminal device 130 may consider switching to the second network device 120.

In some scenarios, if there is a short-time service from the second network device 120 to be processed, such as a paging reception, measurements, a TAU, an RNAU, a MO SMS or the like, the terminal device 130 may perform a short-time switching. In this case, the terminal device 130 may maintain the connection with the first network device 110 and switch to the second network device 120 temporarily:

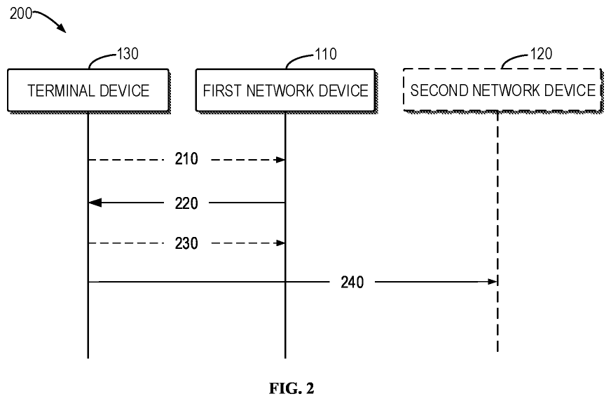

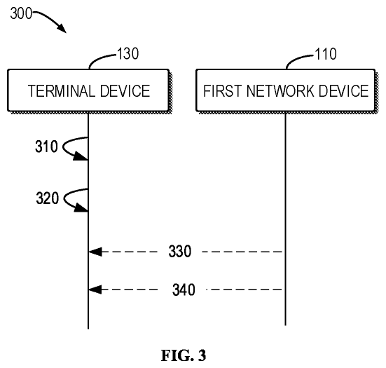

Embodiments of the present disclosure provide improved solutions for the above scenarios. It should be noted that the above scenarios are merely for illustration, and do not make limitation for the present disclosure. Solutions according to embodiments of the present disclosure can apply to any suitable scenarios. For convenience, these solutions will be described in connection with the short-time switching scenarios and with reference to FIGS. 2 and 3.

Example Implementation of Scheduling Gap with Smaller Granularity

FIG. 2 shows a schematic diagram illustrating a process 200 for communication during a switch among networks of multi-USIM according to embodiments of the present disclosure. For the purpose of discussion, the process 200 will be described with reference to FIG. 1. The process 200 may involve the terminal device 130, the first network device 110 and the second network device 120 as illustrated in FIG. 1. Assuming that the terminal device 130 needs to switch from the first network device 110 to the second network device 120.

As shown in FIG. 2, the terminal device 130 may transmit 210 a request for the switching to the first network device 110. In some embodiments, the terminal device 130 may transmit the request with assistance information concerning the switching. In some alternative embodiments, the terminal device 130 may transmit the request without the assistance information concerning the switching. In some embodiments, the terminal device 130 may transmit the request via a RRC message or any other suitable ways. For example, the terminal device 130 may transmit the request with or without the assistance information via a UEAssistanceInformation message.

In some embodiments, the assistance information concerning the switching may comprise a purpose of the switching, for example, a IDLE/IACTIVE state measurement, paging monitoring or the like for second network device 120.

In some embodiments, the assistance information concerning the switching may comprise at least one band expected for the switching. For example, the assistance information may comprise band related information such as a band of a cell of the second network device 120 or a band of the required scheduling gap. As another example, the assistance information may comprise band combination related information such as a band combination (i.e., multiple bands) of the required scheduling gap.

In some embodiments, the assistance information concerning the switching may comprise at least one frequency expected for the switching. For example, the assistance information may comprise frequency related information such as a frequency of a cell of the second network device 120 or a frequency of the required scheduling gap. As another example, the assistance information may comprise frequency range (FR) related information such as a FR of a cell of the second network device 120 or a FR of the required scheduling gap.

In some embodiments, the assistance information concerning the switching may comprise a cell group (CG) expected for the switching, for example, a master cell group (MCG) or a secondary cell group (SCG). In some embodiments, the assistance information concerning the switching may comprise at least one serving cell expected for the switching.

In some embodiments, the assistance information concerning the switching may comprise a direction of a service at the second network device 120. For example, the direction of the service may be only DL. As another example, the direction of the service may be both UL and DL. For example, assuming that the terminal device 130 is of 2 Rx/1 Tx. In case of DL only, the terminal device 130 may continue partial service with the first network device 110, and the first network device 110 may configure the scheduling gap with a smaller granularity. In case of both UL and DL, the terminal device 130 may not continue any service with the first network device 110, and the first network device 110 may configure per-UE scheduling gap (i.e. scheduling gap applied to all serving cells) directly.

With the assistance information concerning the switching, the first network device 110 may configure a suitable scheduling gap for the terminal device 130. Of course, the first network device 110 may also configure the scheduling gap for the terminal device 130 without using the assistance information.

With reference to FIG. 2, the first network device 110 transmits 220 a configuration of the scheduling gap to the terminal device 130. In some embodiments, the first network device 110 may transmit the configuration to the terminal device 130 via a RRC message. Of course, any other suitable ways are also feasible.

In some embodiments, the configuration may comprise a granularity or an applied range of the scheduling gap. According to embodiments of the present disclosure, the scheduling gap is configured with a smaller granularity than a per-UE scheduling gap. In some embodiments, the scheduling gap is configured for a portion of serving cells of the first network device 110. In some alternative embodiments, the scheduling gap may be configured for a portion of a serving cell of the first network device 110. For example, the scheduling gap may be configured for a bandwidth part (BWP). Of course, the scheduling gap may also be configured in any other smaller granularity.

In some embodiments, the first network device 110 may configure a per-CG scheduling gap for the terminal device 130. In this case, the configuration may comprise at least one of a MCG or a SCG to which the scheduling gap is applied (also referred to as a MCG scheduling gap or a SCG scheduling gap). For the MCG scheduling gap, the scheduling gap is only applied to serving cells of the MCG. For the SCG scheduling gap, the scheduling gap is only applied to serving cells of the SCG.

In some embodiments, the first network device 110 may configure a per-band scheduling gap for the terminal device 130. In this case, the configuration may comprise a band to which the scheduling gap is applied. In other words, the scheduling gap is only applied to serving cells belonging to the band.

In some embodiments, the first network device 110 may configure a per-band combination scheduling gap for the terminal device 130. In this case, the configuration may comprise a band combination to which the scheduling gap is applied. In other words, the scheduling gap is only applied to serving cells belonging to the band combination.

In some embodiments, the first network device 110 may configure a per-frequency scheduling gap for the terminal device 130. In this case, the configuration may comprise at least one frequency to which the scheduling gap is applied. In other words, the scheduling gap is only applied to one or more serving cells of the at least one frequency.

In some embodiments, the first network device 110 may configure a per-serving cell scheduling gap for the terminal device 130. In this case, the configuration may comprise at least one serving cell to which the scheduling gap is applied. In other words, the scheduling gap is only applied to the at least one serving cell.

In some embodiments, upon receipt of the configuration, the terminal device 130 may store the configuration. For example, the terminal device may store the configuration in the UE variable. Of course, any other suitable ways are also feasible.

In some embodiments, upon receipt of the configuration, the terminal device 130 may transmit 230 to the first network device 110 a message to indicate the applying of the scheduling gap. For example, the terminal device 130 may transmit a RRCReconfigurationComplete message or any other suitable message.

Based on the configuration of the scheduling gap, the terminal device 130 switches 240 to the second network device 120 while maintaining a RRC connection with the first network device 110. In some embodiments, the terminal device 130 may switch to the second network device 120 during the scheduling gap to handle the service at the second network device 120.

With the process described in connection with FIG. 2, a scheduling gap with a smaller granularity can be configured and used, and thus an interruption of a service at the first network device can be avoided as much as possible.

### Example Implementation of Handling the Overlapping Among Gaps

As mentioned above, a scheduling gap for a network device may be overlapped with another scheduling gap or a measurement gap for the network device. Embodiments of the present disclosure provide solutions for handling the overlapping among gaps. This will be described in detail with reference to FIG. 3. FIG. 3 illustrates a schematic diagram illustrating a process 300 for handling the overlapping among gaps according to embodiments of the present disclosure. For the purpose of discussion, the process 300 will be described with reference to FIG. 1. Assuming that the terminal device 130 needs to switch from the first network device 110 to the second network device 120, and a scheduling gap (also referred to as a first gap herein) for the first network device 110 is configured for the terminal device 130 to switch to the second network device 120. The process 300 may involve the terminal device 130 and the first network device 110 (also referred to as a network device here) as illustrated in FIG. 1.

As shown in FIG. 3, the terminal device 130 determines 310 whether the first gap for the first network device 110 is overlapped with a second gap for the first network device 110. In some embodiments, the second gap may be another scheduling gap for the first network device 110. In some alternative embodiments, the second gap may be a measurement gap for the first network device 110.

If the first gap is overlapped with the second gap, the terminal device 130 determines 320 a first period within the overlapped period for performing a first operation corresponding to the first gap and a second period within the overlapped period for performing a second operation corresponding to the second gap. In other words, the first period and the second period are portions of the overlapped period. Some example implementation for the determination of the first and second periods will be described in connection with Embodiments 1-3.

### Embodiment 1

In this embodiment, the terminal device 130 may determine the first and second periods based on priorities of the first gap and the second gap.

In some embodiments, the first gap and the second gap have different priorities. In some embodiments, the priorities of the first and second gaps may be pre-defined. In some alternative embodiments, the priorities of the first and second gaps may be configured by the first network device 110. In some embodiments, the terminal device 130 may receive 330 from the first network device 110 a configuration indicating whether a priority of the first gap is higher or lower than that of the second gap. For example, the terminal device 130 may receive a configuration indicating that the first gap has a priority higher than that of the second gap. As another example, the terminal device 130 may receive an configuration indicating that the second gap has a priority higher than that of the first gap.

In some embodiments, the terminal device 130 may perform a behavior or operation corresponding to one of the first and second gaps with a higher priority. In some embodiments where the first gap has a priority higher than that of the second gap, the terminal device 130 may determine the first period as the overlapped period and the second period as zero. In some embodiments where the second gap has a priority higher than that of the first gap, the terminal device 130 may determine the first period as zero and the second period as the overlapped period. For example, in case that a scheduling gap is overlapped with a measurement gap and the scheduling gap has a priority higher than that of the measurement gap, the terminal device 130 may perform a short-time service for the second network device 120 during the overlapped period.

In some embodiments, the terminal device 130 may perform a behavior or operation corresponding to one of the first and second gaps with the lowest priority during the overlapped period. In some embodiments where the first gap has a priority lower than that of the second gap, the terminal device 130 may determine the first period as the overlapped period and the second period as zero. In some embodiments where the second gap has a priority lower than that of the first gap, the terminal device 130 may determine the first period as zero and the second period as the overlapped period. For example, in case that a scheduling gap is overlapped with a measurement gap and the scheduling gap has a priority lower than that of the measurement gap, the terminal device 130 may perform a short-time service for the second network device 120 during the overlapped period.

As a modification for Embodiment 1, the terminal device 130 may determine the first and second periods based on priorities of the first and second operations corresponding to the first and second gaps. In some embodiments where the first operation has a priority higher than that of the second operation, the terminal device 130 may determine the first period as the overlapped period and the second period as zero. In some embodiments where the second operation has a priority higher than that of the first operation, the terminal device 130 may determine the first period as zero and the second period as the overlapped period. In this way; the overlapped period will be used for performing an operation corresponding to a gap with a higher priority.

In some alternative embodiments, the overlapped period may also be used for performing an operation corresponding to a gap with a lower priority. In some embodiments where the first operation has a priority lower than that of the second operation, the terminal device 130 may determine the first period as the overlapped period and the second period as zero. In some embodiments where the second operation has a priority lower than that of the first operation, the terminal device 130 may determine the first period as zero and the second period as the overlapped period. In this way, the overlapped period will be used for performing an operation corresponding to a gap with a lower priority.

In some embodiments, the priorities of the first and second operations may be pre-defined. In some alternative embodiments, the priorities of the first and second operations may be configured by the first network device 110. In some embodiments, the terminal device 130 may receive from the first network device 110 a configuration indicating whether a priority of the first operation is higher or lower than that of the second operation. For example, the terminal device 130 may receive a configuration indicating that the first operation has a priority higher than that of the second operation. As another example, the terminal device 130 may receive a configuration indicating that the second operation has a priority higher than that of the first operation.

### Embodiment 2

In this embodiment, the terminal device 130 may determine the first and second periods based on at least one of lengths or periodicities of the first gap and the second gap.

In some embodiments where the first and second gaps are not completely overlapped, the terminal device 130 may performs a behavior corresponding to one of the first and second gaps with a shorter length or longer periodicity during the overlapped period. In some embodiments where the first gap has a length shorter than that of the second gap, the terminal device 130 may determine the first period as the overlapped period and the second period as zero. In some embodiments where the second gap has a length shorter than that of the first gap, the terminal device 130 may determine the second period as the overlapped period and the first period as zero.

In some embodiments where the first gap has a periodicity longer than that of the second gap, the terminal device 130 may determine the first period as the overlapped period and the second period as zero. In some embodiments where the second gap has a periodicity longer than that of the first gap, the terminal device 130 may determine the second period as the overlapped period and the first period as zero.

### Embodiment 3

In this embodiment, the terminal device 130 may determine the first and second periods based on a ratio between the first gap and the second gap within the overlapped period.

For example, the terminal device 130 may performs measurement for the first network device 110 and short-time service for the second network device 120 during the overlapping period based on K1 and K2. The relationship between K1 and K2 is shown in equation (1).

$$\\ \begin{matrix}K 2 = 100 - K 1 & ( 1 )\end{matrix}$$

where K1 denotes the percentage of measurement for the first network device 110, and K2 denotes the percentage of the short-time service for the second network device 120.

In some embodiments, the ratio between the first and second gaps may be pre-defined. In some alternative embodiments, the ratio between the first and second gaps may be configured by the first network device 110. In some embodiments, the terminal device 130 may receive 340 a configuration of the ratio from the first network device 110.

It should be noted that, although embodiments of the present disclosure are described above by taking the overlapping between two gaps as an example, embodiments of the present disclosure also can be applied to the case of the overlapping among more than two gaps. For example, the terminal device 130 may allocate the overlapped period for one of the more than two gaps with a highest priority. As another example, the terminal device 130 may allocate the overlapped period for one of the more than two gaps with a shortest length or a longest periodicity. As still another example, the terminal device 130 may allocate the overlapped period for the more than two gaps based on respective ratios.

With the process described in connection with FIG. 3, the overlapping among gaps can be handled and the behavior during the overlapped period can be specified.

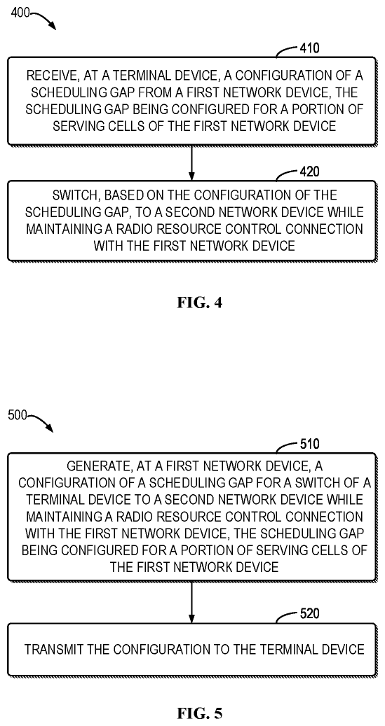

It should be noted that actions shown in FIGS. 2 and 3 are not always necessary for implementing embodiments of the present disclosure, and more or less actions may be adapted as needed. Corresponding to the processes described in FIGS. 2 and 3, embodiments of the present disclosure provide methods of communication implemented at a terminal device and at a network device. These methods will be described below with reference to FIGS. 4 to 6.

### Example Implementation of Methods

FIG. 4 illustrates an example method 400 of communication implemented at a terminal device in accordance with some embodiments of the present disclosure. For example, the method 400 may be performed at the terminal device 130 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

As shown in FIG. 4, at block 410, the terminal device 130 receives a configuration of a scheduling gap from the first network device 110, the scheduling gap being configured for a portion of serving cells of the first network device 110. In some embodiments, the configuration may comprise at least one of the following: at least one of a master cell group or a secondary cell group to which the scheduling gap is applied, at least one band to which the scheduling gap is applied, at least one frequency to which the scheduling gap is applied, or at least one serving cell to which the scheduling gap is applied. In this way, a scheduling gap with a smaller granularity can be used, and interruption of service at the first network device 110 can be avoided as much as possible.

It should be noted that the above configuration is merely an example, and the configuration may adopt any other suitable ways to achieve the scheduling gap with a smaller granularity: For example, the configuration may comprise at least one BWP in a serving cell to which the scheduling gap is applied.

At block 420, the terminal device 130 switches, based on the configuration of the scheduling gap, to the second network device 120 while maintaining a RRC connection with the first network device 110. In some embodiments, the first network device 110 is associated with a first USIM of the terminal device 130 and the second network device 120 is associated with a second USIM of the terminal device 130.

In some embodiments, the terminal device 130 may transmit, to the first network device 110, a message for requesting the switching. The message may comprise assistance information concerning the switching. In this way, the network side is facilitated to generate a more suitable scheduling gap for the terminal device.

In some embodiments, the assistance information may comprise at least one of the following: a purpose of the switching, at least one band expected for the switching, at least one frequency expected for the switching, at least one of a master cell group or a secondary cell group expected for the switching, at least one serving cell expected for the switching, or a direction of a service at the second network device 120. It is to be understood that the assistance information is not limited to these examples, and any other suitable information are also feasible.

FIG. 5 illustrates an example method 500 of communication implemented at a network device in accordance with some embodiments of the present disclosure. For example, the method 500 may be performed at the first network device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

As shown in FIG. 5, at block 510, the first network device 110 generates a configuration of a scheduling gap for a switch of the terminal device 130 to the second network device 120 while maintaining a RRC connection with the first network device 110, the scheduling gap being configured for a portion of serving cells of the first network device 110. In some embodiments, the first network device 110 is associated with a first USIM of the terminal device 130 and the second network device 120 is associated with a second USIM of the terminal device 130.

At block 520, the first network device 110 transmits the configuration to the terminal device 130. In some embodiments, the configuration may comprise at least one of the following: at least one of a master cell group or a secondary cell group to which the scheduling gap is applied, at least one band to which the scheduling gap is applied, at least one frequency to which the scheduling gap is applied, or at least one serving cell to which the scheduling gap is applied. In this way, a scheduling gap with a smaller granularity can be configured, and interruption of service at the first network device 110 can be avoided as much as possible.

It should be noted that the above configuration is merely an example, and the configuration may adopt any other suitable ways to achieve the scheduling gap with a smaller granularity: For example, the configuration may comprise at least one BWP in a serving cell to which the scheduling gap is applied.

In some embodiments, the first network device 110 may receive from the terminal device 130 a message for requesting the switching, the message comprising assistance information concerning the switching. In some embodiments, the first network device 110 may generate the configuration of the scheduling gap by referring to the assistance information. In some alternative embodiments, the first network device 110 may generate the configuration of the scheduling gap without referring to the assistance information.

In some embodiments, the assistance information may comprise at least one of the following: a purpose of the switching, at least one band expected for the switching, at least one frequency expected for the switching, at least one of a master cell group or a secondary cell group expected for the switching, at least one serving cell expected for the switching, or a direction of a service at the second network device 120. It is to be understood that the assistance information is not limited to these examples, and any other suitable information are also feasible.

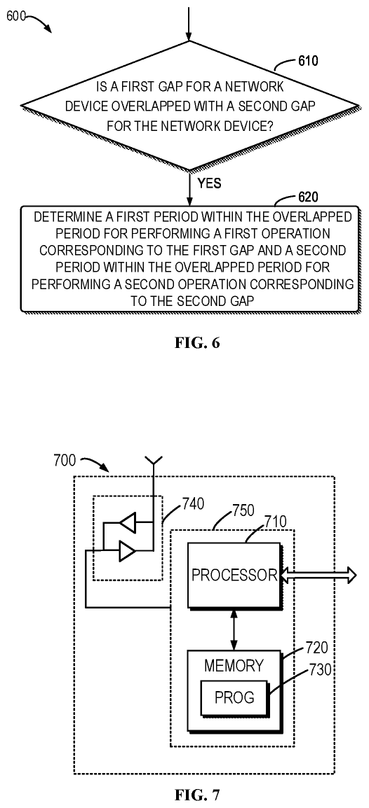

FIG. 6 illustrates another example method 600 of communication implemented at a terminal device in accordance with some embodiments of the present disclosure. For example, the method 600 may be performed at the terminal device 130 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

As shown in FIG. 6, at block 610, the terminal device 130 determines whether a first gap for a network device (for example, the first network device 110) is overlapped with a second gap for the first network device 110. In some embodiments, the first gap is a scheduling gap and the second gap is another scheduling gap. In some alternative embodiments, the first gap is a scheduling gap and the second gap is a measurement gap.

If the first gap is overlapped with the second gap, the process proceeds to block 620. At block 620, the terminal device 130 determines a first period within the overlapped period for performing a first operation corresponding to the first gap and a second period within the overlapped period for performing a second operation corresponding to the second gap. In this way, the overlapping among gaps can be handled and the behavior of the terminal device during the overlapped period can be specified.

In some embodiments, the terminal device 130 may determine the first and second periods based on priorities of the first gap and the second gap. In some embodiments where the first gap has a priority higher than that of the second gap, the terminal device 130 may determine the first period as the overlapped period and the second period as zero. In some embodiments where the second gap has a priority higher than that of the first gap, the terminal device 130 may determine the first period as zero and the second period as the overlapped period.

In some embodiments, the priorities of the first and second gaps may be pre-defined. In some embodiments, the priorities of the first and second gaps may be configured by the network side. In some example embodiments, the terminal device 130 may receive, from the first network device 110, an indication indicating that the first gap has a priority higher than that of the second gap. In some example embodiments, the terminal device 130 may receive, from the first network device 110, a configuration indicating that the second gap has a priority higher than that of the first gap.

In some embodiments, the terminal device 130 may determine the first and second periods based on priorities of the first and second operations corresponding to the first gap and the second gap. In some embodiments, the priorities of the first and second operations may be pre-defined. In some embodiments, the priorities of the first and second operations may be configured by the network side.

In some embodiments, the terminal device 130 may determine the first and second periods based on at least one of lengths or periodicities of the first gap and the second gap. In some embodiments where the first gap has a length shorter than that of the second gap, the terminal device 130 may determine the first period as the overlapped period and the second period as zero. In some embodiments where the second gap has a length shorter than that of the first gap, the terminal device 130 may determine the second period as the overlapped period and the first period as zero. In some embodiments where the first gap has a periodicity longer than that of the second gap, the terminal device 130 may determine the first period as the overlapped period and the second period as zero. In some embodiments where the second gap has a periodicity longer than that of the first gap, the terminal device 130 may determine the second period as the overlapped period and the first period as zero.

In some embodiments, the terminal device 130 may determine the first and second periods based on a ratio between the first gap and the second gap within the overlapped period. In some embodiments, the ratio may be pre-defined. In some embodiments, the ratio may be configured by the network side. In some example embodiments, the terminal device 130 may receive a configuration of the ratio from the first network device 110.

The operations of steps in methods 400-600 are similar with that described in connection with FIGS. 2 and 3, and thus other details are not repeated here.

### Example Implementation of Device

FIG. 7 is a simplified block diagram of a device 700 that is suitable for implementing embodiments of the present disclosure. The device 700 can be considered as a further example implementation of the first network device 110, the terminal device 130, or the second network device 120 as shown in FIG. 1. Accordingly, the device 700 can be implemented at or as at least a part of the first network device 110, the terminal device 130, or the second network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a terminal device comprises circuitry configured to: receive a configuration of a scheduling gap from a first network device, the scheduling gap being configured for a portion of serving cells of the first network device; and switch, based on the configuration of the scheduling gap, to a second network device while maintaining a radio resource control connection with the first network device, the first network device being associated with a first subscriber identity module of the terminal device and the second network device being associated with a second subscriber identity module of the terminal device.

In some embodiments, the configuration may comprise at least one of the following: at least one of a master cell group or a secondary cell group to which the scheduling gap is applied, at least one band to which the scheduling gap is applied, at least one frequency to which the scheduling gap is applied, or at least one serving cell to which the scheduling gap is applied.

In some embodiments, the circuitry may be further configured to transmit, to the first network device, a message for requesting the switching, the message comprising assistance information concerning the switching.

In some embodiments, the assistance information may comprise at least one of the following: a purpose of the switching, at least one band expected for the switching, at least one frequency expected for the switching, at least one of a master cell group or a secondary cell group expected for the switching, at least one serving cell expected for the switching, or a direction of a service at the second network device.

In some embodiments, a terminal device comprises circuitry configured to: determine whether a first gap for a network device is overlapped with a second gap for the network device, the first gap being a scheduling gap, the second gap being another scheduling gap or a measurement gap; and in accordance with a determination that the first gap is overlapped with the second gap, determine a first period within the overlapped period for performing a first operation corresponding to the first gap and a second period within the overlapped period for performing a second operation corresponding to the second gap.

In some embodiments, the circuitry may be configured to determine the first and second periods based on priorities of the first gap and the second gap. In some embodiments, the circuitry may be configured to determine the first period as the overlapped period and the second period as zero in accordance with a determination that the first gap has a priority higher than that of the second gap, and determine the first period as zero and the second period as the overlapped period in accordance with a determination that the second gap has a priority higher than that of the first gap.

In some embodiments, the circuitry may be further configured to receive, from the network device, a configuration indicating that the first gap has a priority higher than that of the second gap: or receive, from the network device, a configuration indicating that the second gap has a priority higher than that of the first gap.

In some embodiments, the circuitry may be configured to determine the first and second periods based on priorities of the first and second operations corresponding to the first gap and the second gap.

In some embodiments, the circuitry may be configured to determine the first and second periods based on at least one of lengths or periodicities of the first gap and the second gap. In some embodiments, the circuitry may be configured to determine the first period as the overlapped period and the second period as zero in accordance with a determination that the first gap has a length shorter than that of the second gap, and determine the second period as the overlapped period and the first period as zero in accordance with a determination that the second gap has a length shorter than that of the first gap.

In some embodiments, the circuitry may be configured to determine the first period as the overlapped period and the second period as zero in accordance with a determination that the first gap has a periodicity longer than that of the second gap, and determine the second period as the overlapped period and the first period as zero in accordance with a determination that the second gap has a periodicity longer than that of the first gap.

In some embodiments, the circuitry may be configured to determine the first and second periods based on a ratio between the first gap and the second gap within the overlapped period. In some embodiments, the circuitry may be further configured to receive a configuration of the ratio from the network device.

In some embodiments, a first network device comprises circuitry configured to: generate a configuration of a scheduling gap for a switch of a terminal device to a second network device while maintaining a radio resource control connection with the first network device, the scheduling gap being configured for a portion of serving cells of the first network device, the first network device being associated with a first subscriber identity module of the terminal device and the second network device being associated with a second subscriber identity module of the terminal device; and transmit the configuration to the terminal device.

In some embodiments, the configuration may comprise at least one of the following: at least one of a master cell group or a secondary cell group to which the scheduling gap is applied, at least one band to which the scheduling gap is applied, at least one frequency to which the scheduling gap is applied, or at least one serving cell to which the scheduling gap is applied.

In some embodiments, the circuitry may be further configured to receive, from the terminal device, a message for requesting the switching, the message comprising assistance information concerning the switching.

In some embodiments, the assistance information may comprise at least one of the following: a purpose of the switching, at least one band expected for the switching, at least one frequency expected for the switching, at least one of a master cell group or a secondary cell group expected for the switching, at least one serving cell expected for the switching, or a direction of a service at the second network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-22. (canceled)

23. A method of communication performed by a terminal device, the method comprising:
receiving, from a network device, first information indicating a first gap and a second gap;
receiving, from the network device, second information indicating a first priority for the first gap and a second priority for the second gap;
determining that the first gap and the second gap are colliding; and
performing an operation in the second gap, in accordance with a determination that the second priority is higher than the first priority.

24. The method of claim 23, further comprising:
dropping the first gap.

25. The method of claim 23, wherein performing the operation is performing a measurement.

26. The method of claim 23, wherein the operation is for Multi-Universal Subscriber Identity Module (MUSIM).

27. A method of communication performed by a network device, the method comprising:
transmitting, to a terminal device, first information indicating a first gap and a second gap;
transmitting, to a terminal device, second information indicating a first priority for the first gap and a second priority for the second gap,
wherein,
the first gap and the second gap are determined to be colliding, and
an operation in the second gap is performed in accordance with a determination that the second priority is higher than the first priority.

28. The method of claim 27, wherein the first gap is dropped.

29. The method of claim 27, wherein the operation is a measurement.

30. The method of claim 27, wherein the operation is for Multi-Universal Subscriber Identity Module (MUSIM).

31. A terminal device, the method comprising:
at least one memory having programs instructions stored therein;
at least on processor configured to execute the program instructions that when executed performs a process comprising:
receiving, from a network device, first information indicating a first gap and a second gap;
receiving, from the network device, second information indicating a first priority for the first gap and a second priority for the second gap;
determining that the first gap and the second gap are colliding; and
performing operation in the second gap, in accordance with a determination that the second priority is higher than the first priority.

32. The terminal device of claim 31, the process further comprises:
dropping the first gap.

33. The terminal device of claim 31, wherein performing the operation is performing a measurement.

34. The terminal device of claim 31, wherein the operation is for Multi-Universal Subscriber Identity Module (MUSIM).
